(19) United States
(12) Patent Application Publication
(10) Pub. No.: US 2025/0259212 A1
(43) Pub. Date: Aug. 14, 2025

(54) Method and Computer System for Matching Donors

(71) Applicant: RonDerrick Johnson, Dallas, TX (US)

(72) Inventor: RonDerrick Johnson, Dallas, TX (US)

(21) Appl. No.: 19/190,735

(22) Filed: Apr. 27, 2025

Related U.S. Application Data
(63) Continuation-in-part of application No. 18/108,645, filed on Feb. 12, 2023.
(60) Provisional application No. 63/318,033, filed on Mar. 9, 2022.

(51) Int. Cl. G06Q 30/0279; G06Q 30/0203; G06Q 30/0601; G06Q 50/22

(52) U.S. Cl. CPC G06Q 30/0279; G06Q 30/0203; G06Q 30/0613; G06Q 50/22

(57) ABSTRACT

A digital system for product-donation fundraising using a social network enables the direct delivery of essential products to individuals, families, and charity organizations in need. The system includes: (1) an interface module for generating an interface that allows users to communicate within the social donating network; (2) a profile module for creating and managing user profiles with differentiated access based on need classification; (3) a verification module using API integration to verify charity organizations; (4) a needs assessment engine based on official United States poverty guidelines; (5) a product selection module enabling recipients to browse and select essential products from partner retailers; (6) a matching algorithm connecting recipient needs with potential donors; and (7) a secure payment processing system integrating with third-party logistics for direct product delivery.

### FIELD OF THE INVENTION

The present invention relates to computerized systems and methods for matching the essential product needs of indigent individuals, families, and charity organizations with donors. More particularly, after the recipients' needs and the donor match has been established, the present invention relates to the logistical analysis required for the delivery of the product donation from the merchant to the front door of the recipient using a third-party delivery service. The invention is implemented through a specialized mobile application platform connected to a sophisticated backend system incorporating machine learning algorithms for optimizing recipient-donor matching, secure payment processing, needs verification protocols, real-time order tracking, and database management for storing and analyzing user information while maintaining regulatory compliance with financial and privacy laws.

### BACKGROUND OF THE INVENTION

Until now, donations to individuals, families, and charities are regulated to monetary or used product donations being facilitated and distributed from a central hub. While it is always admirable to give to the less fortunate, there is a broad range of concerns with such antiquated system of giving. Particularly, there is an apparent question as to the appropriation of monetary funds given in relation to a recipient's need. How can anyone be certain that every penny that is donated is actually being used for the reason identified in the fundraiser. It is not unusual for a fundraising campaign to be falsely created in the name of a prominent entertainer, athlete, or individual in difficult circumstances. Unfortunately, there are people who would exploit the tragic circumstances of these heart-wrenching stories and use them to scam unsuspecting individuals out of hundreds, thousands, and even millions of dollars.

Fundraising platforms are ill-prepared to address the wide range of specific needs of those living in poverty. So many people need essential food, medical, clothing, and hygiene supplies just to name a few. The vast majority of these needs are under-scoped and under-served due to a lack of resources. What is more, even if the resources did exist, there exists no infrastructure to deliver the products to the recipients who so desperately need them. Therefore, in a feeble effort to collect the money and essential products that so many require, thrift stores, donation centers, food pantries, and fundraising tools have been established throughout communities around the globe. However, the dilemma of how to protect funds and deliver products to immobile donation recipients still exists.

Other than the obtainment of personal receipts of purchase, it is almost impossible for a donor to know how their monetary contribution is being used. Furthermore, a donation center can only suggest that people without any means to retrieve essential products somehow find a way to retrieve the products they so desperately need. Thus, in order to meet the needs of the poverty community, effective logistical strategies must target the gaps that exist in the current donation systems. Such methods must address who, what, when, where, and how a recipient in need will receive their donations. These are the problems that currently exist that this invention endeavors to solve to the benefit of all who are in need.

The process of managing a product donation campaign from start to finish can be an arduous task. Ensuring that donation contributions reach the hands of the desired recipient can be highly complex. There are multiple entities that must communicate efficiently to execute a successful fundraiser.

For example, products often must reach the end of their product life cycle before they are considered for repurposing or redistribution. To this extent, products are then marked down in price and distributed through a secondary retailer. These include the Salvation Army and the Good Will for example. Numerous contractors are in place for the receiving of both the products as well as the needs of the final recipients (e.g., living in shelters, homeless, halfway-houses or orphanages). Many of these organizations lack the manpower to record the specific needs of the communities they serve. There is a lack of resource funding necessary to supplement what a charity organization may require to hire an adequate support staff. Project budgets typically include labor, equipment such as computers, modes of transportation for pick up and deliveries. Also, inventory controllers, storage facilities, customer service representatives to ensure quality control as well as legal compliances.

Another barrier is the fact that many of those seeking assistance lack the means of transportation to pick up their products should they become available. In the event that a charity has the essential products that a recipient requires, if that person is disabled or immobile, they are unable to reach the facilities to retrieve the donation. In some cases, an indigent recipient may receive financial support which would do little to assist a person if they are unable to properly spend the funds. These are just a few of the budgeting areas that impede the efficacy of meeting the needs of impoverished communities.

Whatever a charity organization receives in resources may be significantly less than what they may receive in monetary funding. Typically, the monies received have been pre-allocated for a specific subpopulation who possess the most urgent needs. In this case, once the resources are depleted, so many others go without the products that they need. Many who seek help from charity organizations are pooled into a bank along with thousands of other recipients. Meeting the financial needs of those living in poverty is regulated to a “first come—first serve” process. While financial contributions are collected from all over the world, there are minimal safeguards in place to eliminate the misallocation and misappropriation of these funds. Misappropriation of funds means the intentional, illegal use of the funds of another person for one's own use or other unauthorized purpose. One of the primary reasons for this lack in financial accountability stems from the fact that the majority of fundraising platforms are all 501c nonprofit organizations. Therefore, they are not held to the same level of scrutiny by the IRS as does there for-profit counterparts. Nonprofits are similar to corporate business entities in many aspects, although there are usually significant differences in the way operations get conducted. Nonprofit organizations have a tremendous advantage with the status because they are not usually required to disclose their financial situation to anyone. That provision even includes members and partners of their organization. There are no disclosure requirements that can get enforced unless a violation of their 501(c) status occurs.

Because of the economic positioning of nonprofit organizations and the lack of accountability, there exists a large need to close the gap between the contributions received by these organizations and the allocation of those funds. Most of the time, it is an innocent attempt by a board or by an Executive Director to be good stewards of the money people have donated. With completely innocent and positive intent, they proceed to act in a manner that is totally against the rules.

Some of the ways that funds can be misappropriated is by using restricted funds that are set aside for a particular purpose. Another way is through solicited designations. A solicitation means that an organization asked for donations for a particular cause. Maybe it was by letter, email, website, radio spot . . . it doesn't really matter. What matters is that donations given in response to a direct solicitation are to be dedicated to that purpose. In our homeless shelter example, the board cannot simply redirect the use of the money from the facilities account to the food account, no matter how dire the circumstances, if those funds are the result of a solicitation.

A need exists for effectively getting resources into the hands of individuals, families, and charity organizations in need. There are very few methods in place that can adequately identify and meet the needs of the less fortunate. Even more importantly than the need to increase donation awareness, there must be a way to systematize the appropriate allocation of financial donations. This invention seeks to provide a solution for the identification of the needs of individuals, families and charity organizations.

### SUMMARY OF THE INVENTION

This summary provides a general scope of the systems and methods of the invention. The concepts presented here will be further elaborated upon in the detailed description. The invention implements a comprehensive digital platform that systematically identifies, authenticates, categorizes, and connects users within a specialized donation ecosystem designed to deliver essential products directly to those in need while eliminating the misappropriation of donated funds.

The present invention comprises several integrated technological components: (1) a User Classification and Authentication System providing a multi-tiered system for classifying users as donors, general recipients, critical needs recipients, or charity organizations, each with specific access permissions and features; (2) a Needs Assessment Engine utilizing AI-driven systems and official United States poverty guidelines to automatically categorize users based on their responses to the indigency questionnaire; (3) a Product Selection and Categorization Module implementing a database-driven system for organizing, displaying, and selecting essential products across multiple categories; (4) a Donor-Recipient Matching Algorithm providing a proprietary matching system that connects recipients with appropriate donors based on multiple parameters including need level, geographic proximity, donation history, and product urgency; (5) a Secure Payment Processing Infrastructure with PCI-compliant payment system integrated with multiple payment gateways to process and track donations; (6) a Delivery Coordination System providing a logistics interface connecting the platform with third-party delivery services for product acquisition and delivery; (7) a Digital Receipt and Tax Documentation Generator that automates the creation, storage, and distribution of donation receipts and tax documentation; (8) a Database Management System providing a secure, scalable database architecture for storing user information, transaction histories, product data, and system logs; and (9) an API Integration Framework for connecting with external services including charity verification APIs, payment processors, and delivery services.

Indigent individuals and families using the eBono mobile application are classified into two primary categories through a sophisticated qualification process. Critical Needs Recipients are users who fall below the official United States poverty guidelines for their household size, as determined through our indigency assessment algorithm. These users receive priority status in the system, have increased visibility to potential donors, can access broader donor pools beyond their personal contacts, may have access to specialized product categories, and undergo additional verification procedures to confirm status. General Recipients are users who may not meet technical poverty guidelines but demonstrate inability to access essential products. These users can request donations primarily from their personal contact networks, have standard access to product categories, and may have time-limited frequency restrictions on donation requests.

Donor Users are individuals who contribute funds for product donations, with capabilities to browse recipient profiles and needs requests, review recipient donation histories, select specific donation requests to fulfill, receive tax documentation for their contributions, and track delivery status of their donations. Charity Organizations are verified non-profit entities that can register through a specialized verification process using API integration with charity database services, create organizational profiles, specify needs for communities they serve, access aggregate donation data and analytics, and generate specialized tax documentation.

The server infrastructure for the invention comprises an Application Layer that implements the user interface and business logic, delivering the mobile application experience; a Database Layer with a distributed database system for storing user profiles with encrypted personal information, transaction records with unique identifiers, product catalogs synchronized with retail partners, delivery tracking data, and system logs and analytics; a Processing Layer that handles computational tasks including needs assessment calculations, matching algorithms, payment processing, security protocols, and report generation; and an Integration Layer that connects with external systems including payment gateways (PayPal, Stripe, etc.), third-party delivery services, charity verification databases, and retail inventory systems.

The invention implements a sophisticated permissions system to control data access. Location Services are requested to access the user's precise location data to pinpoint product delivery locations, match recipients with nearby donors, connect with local retail partners, and optimize delivery routing. Contact List Access, upon user authorization, enables the system to access contact information to enable targeted donation requests to personal networks, build donor communities, facilitate donation sharing and amplification, and implement social network integration.

The system implements comprehensive tracking mechanisms for product selection timestamps, payment processing verification, delivery status monitoring, delivery confirmation, receipt generation, tax documentation preparation, donation history aggregation, and usage pattern analysis for fraud prevention.

The computing implementation consists of a distributed architecture with redundant servers, load balancing, and failover mechanisms. The system employs a microservices architecture for modularity and scalability, with separate services handling different functional aspects: user management, product catalog, payment processing, delivery coordination, and analytics.

The entire system leverages industry-standard security protocols including end-to-end encryption for sensitive data, two-factor authentication for account access, secure API communication with external services, and comprehensive audit logging to ensure data integrity and security.

A key innovation of this system is its ability to completely eliminate financial misappropriation by never transferring cash directly to recipients, instead processing payments through a secure ecosystem that ensures funds are used exclusively for the purchase and delivery of essential products.

### BRIEF DESCRIPTION OF THE DRAWINGS

FIG. 1 is an illustration of an online platform consistent with various embodiments of the present disclosure, showing a centralized server communicating with various network entities over a communication network.

FIG. 2 is an illustration of a system consistent with an embodiment of the disclosure, showing the computing device components including processing unit, system memory, and communication connections.

FIG. 3 is a process flow diagram illustrating the method for facilitating delivery of products, showing the sequence of steps for product donation matching and delivery.

FIGS. 4A-E are graphical user interface screens of the mobile application capable of facilitating delivery of products. FIG. 4A shows a search results interface. FIG. 4B displays a product details page. FIG. 4C presents a geolocation page for store selection. FIG. 4D illustrates a store listing interface sorted by price, distance, and stock. FIG. 4E shows a delivery methods selection screen.

FIG. 5 is a graphical user interface screen showing shopping list management within the mobile application.

FIG. 6 illustrates the sequence of steps performed to construct a products search results page.

FIG. 7 This mockup shows the administrative function interface that facilitates donations and product/recipient acquisition. It includes verification queues, order processing panels, and system analytics.

FIG. 8 This illustrates how donors can select specific items from a recipient's list, with some items already funded and others waiting for donations. It clearly shows that remaining items become available for other donors.

FIG. 9 illustrates drawing demonstrates how donors can select from verified charity organizations and choose to donate to specific individuals within that organization.

FIG. 10 illustrates the updated recipient donation model where recipients receive donation amounts for specified time periods rather than selecting from price categories, addressing point #7.

FIG. 11 illustrates how charity organizations have no specified amount limits or time frames for donations.

FIG. 12 illustrates the current AI components and potential future AI advancements that could be integrated into the system.

FIG. 13 illustrates all components of the total donation cost including product cost, taxes, delivery fees, and administrative costs.

### DETAILED DESCRIPTION OF THE INVENTION

The following invention description reflects the various illustrative embodiments, reference is made to the provided drawings of various embodiments which demonstrate aspects of the disclosure and how it may be practiced. It is to be understood that additional embodiments may also be used along with structural modifications without deviating from the overarching scope of the present disclosure.

### System Overview

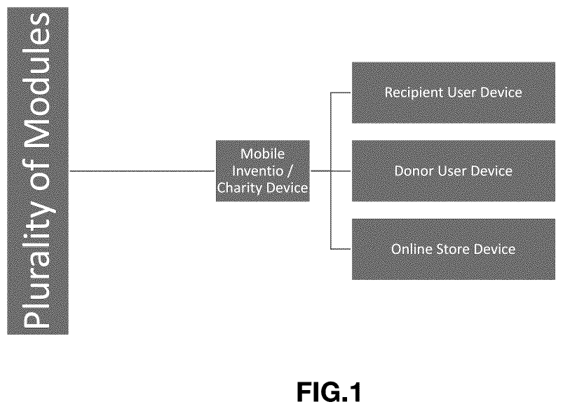

Referring to FIG. 1, an online platform is illustrated consistent with various embodiments of the present disclosure. The online platform is designed to enable the facilitation of management of user data and may be hosted on a centralized server, such as a cloud computing service. The centralized server may communicate with other network entities, such as smartphones, desktop computers, mobile devices, laptops, tablet computers, and other electronic devices, server computers, databases, and sensors over a communication network, such as, but not restricted to, the Internet.

Users of the online platform may include but are not limited to, third party delivery services, department stores, grocery stores, medical facilities, end-users, administrators, charity organizations, service providers, service consumers, government facilities and so on. In various situations, electronic devices operated by the one or more relevant parties may be in communication with the presented platform.

A web-based software application or browser may be used to allow one or more relevant users to access the online platform. The web-based software application may be externalized as a website, desktop application, a web application, and/or a mobile application compatible with an electronic apparatus.

### System Architecture and Technical Implementation

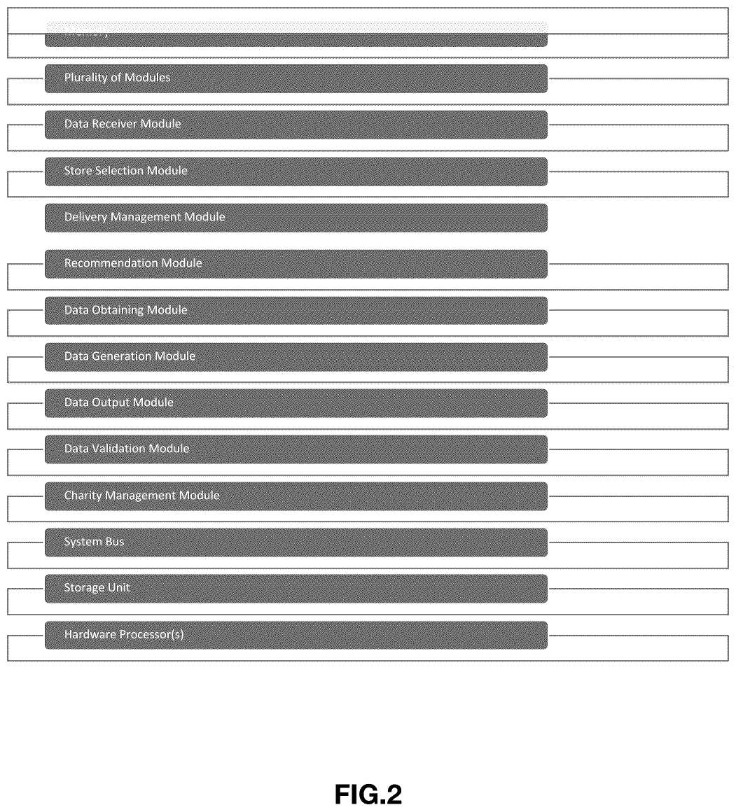

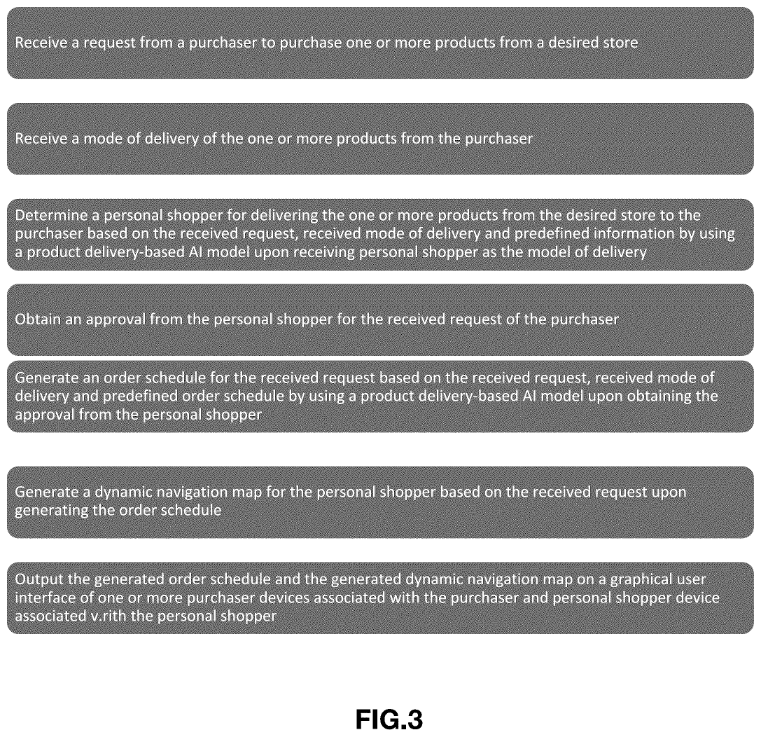

With reference to FIG. 2, the system implements a multi-tiered architecture consistent with the embodiment of the disclosure. This architecture includes both client-side components (mobile application) and server-side infrastructure (cloud computing environment).

The central computing environment consists of a distributed cloud-based system that includes: (1) Application Servers: High-performance computing nodes running the core business logic, implemented as containerized micro-services for scalability and fault tolerance. These servers handle authentication and authorization services, API request processing, business logic execution, session management, and rate limiting and request throttling; (2) Database Cluster: A distributed database system consisting of primary relational database (PostgreSQL) for transactional data, document database (MongoDB) for flexible schema storage of user profiles and preferences, in-memory cache (Redis) for session data and frequent queries, and data warehousing solution for analytics and reporting; (3) Message Queue System: An asynchronous communication infrastructure (RabbitMQ) managing order processing workflows, notification dispatch, task scheduling, and system event propagation; and (4) Content Delivery Network: Distributed edge servers caching static assets to improve global performance and reduce latency.

In a basic configuration, each computing node includes at least one processing unit (implemented as multi-core CPUs optimized for parallel processing) and a system memory (configured with high-speed ECC RAM for data integrity). The system implements redundancy with active-passive failover configurations to ensure high availability.

The system memory comprises several specialized components: volatile memory (RAM): Primary workspace for active processing; non-volatile memory (ROM): Storing boot sequences and firmware; and flash memory: For system recovery and configuration persistence.

The operating system is a hardened Linux distribution optimized for server performance with enhanced security modules. The programming modules are implemented primarily in Java and Node.js, with performance-critical components written in Go for enhanced concurrency handling.

### Storage Architecture

The system implements a tiered storage architecture with multiple redundancy layers: (1) Primary Storage (System memory): High-speed access for active processes; (2) Secondary Storage including Removable storage: Hot-swappable SSD arrays for maintenance, and Non-removable storage: High-capacity NVMe storage for databases; and (3) Backup and Archive System with Automated daily incremental backups, Weekly full system backups, Geographically distributed data replication, and Encrypted cold storage for long-term archiving.

The storage infrastructure supports advanced features including data deduplication to optimize storage efficiency, automated data lifecycle management, point-in-time recovery capabilities, and encrypted data at rest using AES-256 encryption.

### Network Architecture

The system's communication layer consists of: (1) External Communication: Communication connection 216 implements a multi-layered approach with TLS 1.3 encryption for all external traffic, Web Application Firewall (WAF) for request filtering, DDoS protection services, and API gateway for request routing and throttling; (2) Internal Communication with High-speed private network between system components, Service mesh architecture for inter-service communication, Virtual Private Cloud (VPC) isolation, and Internal certificate authority for service authentication; and (3) Third-Party Integration with Secure API endpoints for payment processors, Webhook handlers for delivery service integrations, OAuth 2.0 flows for external authentication providers, and Dedicated VPN connections to strategic partners.

### Client Application Architecture

The mobile application is implemented as a hybrid application combining native performance with cross-platform compatibility: (1) Presentation Layer with React Native for UI components, Native modules for platform-specific functionality, Custom rendering engine for optimized list views, and Offline-first design for functionality without connectivity; (2) Business Logic Layer with State management using Redux, Middleware for API communication, Local storage for offline data persistence, and Background processing for non-critical tasks; and (3) Device Integration Layer with GPS and location services integration, Contact list access module, Push notification handling, and Camera integration for scanning and verification.

The system architecture is designed with scalability as a primary consideration, capable of handling millions of users with linear resource scaling through horizontal expansion of computing resources.

### User Types and System Interaction Model

The platform implements a multi-actor ecosystem with differentiated access controls, verification procedures, and functionality based on user classification. This section details the technical implementation of user types and their interactions within the system.

### 1. General Recipients

General Recipients are implemented as a user class with the following technical characteristics: (1) Database Schema: Stores user profile with attributes including Unique user identifier (UUID), Authentication credentials (hashed and salted), Contact information (phone, email, physical address), Need classification code (1=general), Geographic coordinates (latitude/longitude), Request history with timestamps, Request frequency monitoring counters, Profile completion percentage, Trust score (algorithmic calculation based on system usage), and Device identifiers for fraud prevention; (2) Access Control Limitations that Programmatically restrict sharing donation requests only with users in their contact graph, Limit to a configurable number of active donation requests (default: 3), Subject to cool-down periods between requests within the same price tier, and Access to standard product categories only; and (3) System Interaction with Standard API rate limits, Automated review triggers for unusual activity patterns, and Limited dashboard analytics.

### 2. Critical Needs Recipients

Critical Needs Recipients implement an extended user class inheriting from the base recipient class with enhanced attributes: (1) Database Schema Extensions including Need classification code (2=critical), Verification documents (securely stored with encryption), Eligibility expiration date, Priority weighting factor (floating point 1.0-3.0), Extended need assessment data, and Specialized product category permissions; (2) Enhanced Permissions with Algorithmic prioritization in donor-facing discovery interfaces, Access to expanded product categories, Higher request limits (configurable, default: 5 active requests), Eligibility for emergency fulfillment queueing, and Access to donation amplification from organizational donors; and (3) Additional Security Measures with Enhanced verification workflow, Periodic re-verification triggers, and Additional fraud detection monitoring.

### 3. Donor Users

Donor users implement a contributor class with the following infrastructure: (1) Database Schema including Donor classification code (3=individual donor), Payment methods (tokenized, not stored directly), Donation history with timestamps and recipient mappings, Tax documentation eligibility flag, Communication preferences, Preferred donation categories, Geographic donation radius preference, Recurring donation configurations, and Donor privacy settings; and (2) Functional Capabilities with Access to filtered recipient discovery interface, Donation analytics dashboard, Receipt generation API access, Custom notification preferences, Integration with external payment processors, and Donation sharing tools for social amplification.

### 4. Charity Organizations

Charity Organizations implement an organizational entity class with the following infrastructure: (1) Database Schema including Organization classification code (4=verified charity), EIN or equivalent identifier, Verification status and timestamp, Administrative user accounts (multiple with role-based access control), Service population attributes, Geographic service boundaries, Special handling instructions, Bulk delivery capabilities flag, and Analytics access permissions; and (2) Extended Functionality with Bulk recipient management dashboard, Organization-specific donation landing pages, Enhanced analytics dashboard with exportable reports, API integration capabilities for existing systems, Custom branding options within the platform, and Specialized tax documentation generation.

### Multi-Factor Authentication and Onboarding Workflow

The system implements a sophisticated, security-focused onboarding workflow with multiple stages: (1) Initial Authentication including Phone Number Verification (User enters phone number in E.164 format, System generates cryptographically secure OTP with time-based expiration, OTP delivered via SMS using Twilio API integration, Client-side entry validation with rate-limiting protection, Server-side verification against stored hash, and Device fingerprinting for future logins) and Email Verification (Parallel Process) (User enters email address, System generates unique confirmation token with 24-hour expiration, Verification email dispatched via SendGrid with tracking, Click tracking for completion analytics, Email verification status flagged in database, and Periodic reminder system for incomplete verifications); (2) Profile Creation including Identity Information Collection (Progressive disclosure interface collecting Legal name (given name, family name), Date of birth (for age verification and demographic analysis), Physical address with geocoding verification, and Optional demographic information; Real-time address validation against USPS/Google Maps APIs; Form field validation with immediate feedback; and Secure storage with field-level encryption for PII) and Permission Management (Location services permission request with Precise location for delivery services, Background location disabled, and Geofencing capabilities for delivery notifications; and Contact list permission request with One-time import with local hashing, Contact match identification without full list transmission, and Permission revocation handling); and (3) Needs Assessment Engine for recipient users with Assessment Questionnaire (Dynamic form generation based on household composition, Income verification questions mapped to federal poverty guidelines, Special circumstances assessment (disability, medical conditions, etc.), Temporary versus chronic need differentiation, and Automated weighting algorithm), Classification Determination (Real-time calculation against current federal poverty thresholds, Household size adjustment algorithm, Geographic cost-of-living index application, Final classification score generation (0.0-10.0 scale), and Threshold application (configurable, default: ≥7.5=Critical Needs)), and Verification Processing (Conditional document upload requests based on responses, Machine learning document verification, Manual review queueing for edge cases, Classification override capabilities for administrative users, and Fraud pattern detection).

The entire onboarding process implements progressive data collection with session persistence, allowing users to complete the process across multiple sessions without data loss. The system maintains comprehensive audit logs of all classification decisions for compliance purposes.

### Product Selection and Request Process

The stores listed on the mobile application invention were directly derived from the third-party delivery service application. The third-party delivery service being used for the delivery of the product donations includes every store and product listed on the mobile application invention.

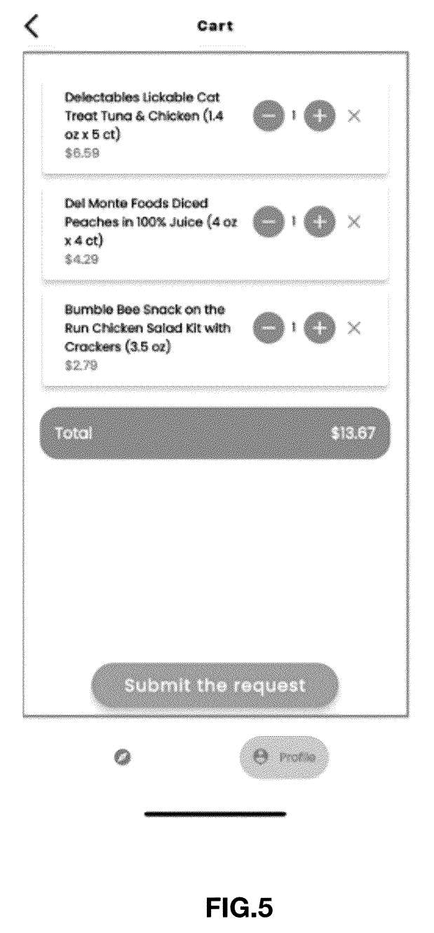

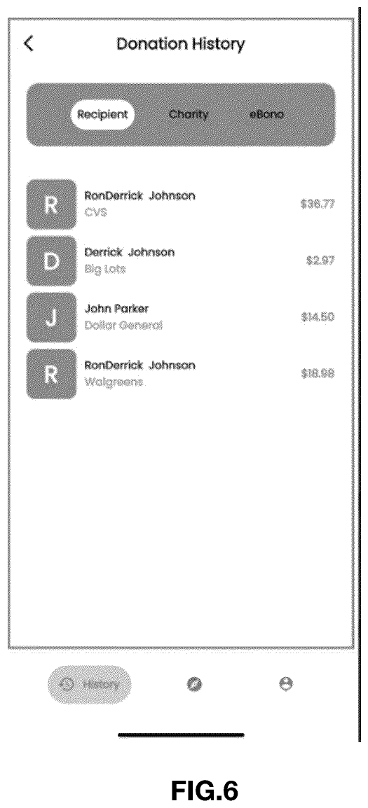

FIG. 6 illustrates the sequence of steps that are performed to construct a products search results page. In a first step, the user is prompted to select a product category from the list of essential item categories provided.

The next step is for the user to select the essential products that they need. Product categories include: Non-perishable foods, Infant/Child care, Hygiene, Over-the-counter medicines, Essential household cleaning supplies, Essential clothing, Essential pet supplies, and additional categories that may be added as needed.

In a third step shown in FIG. 6, the query is applied to all of the categories comprising the All Products search. As illustrated in FIG. 1, the query is submitted by the query server via the search tool to a separate database associated with each category. Each product database is indexed by keyword to facilitate searching by the search tool.

In a fourth step shown in FIG. 6, the query results are returned from each of the product databases, via the search tool, to the query server. The search tool prioritizes the results within each category according to a determination of relevance based upon the query terms.

### Comprehensive Security Architecture

The system implements a defense-in-depth security strategy with multiple protective layers, encryption protocols, and fraud prevention mechanisms. The Application Security Infrastructure includes Advanced Code Obfuscation with Symbol renaming using non-deterministic algorithms, Control flow flattening to prevent reverse engineering, String encryption for hardcoded credentials and URLs, Dead code injection to complicate static analysis, and Native code protection for critical security functions. The security architecture also implements Runtime Application Self-Protection (RASP) with Dynamic integrity checking during execution, API hooking detection and prevention, Real-time tampering detection with kill switch capabilities, Emulator/simulator detection algorithms, and Jailbreak/root detection with tiered response mechanisms. Additionally, Binary Hardening measures include Position Independent Executable (PIE) implementation, Address Space Layout Randomization (ASLR) enforcement, Stack canaries for buffer overflow protection, Secure compiler flags for hardening binaries, and Removal of unnecessary debug information.

The Communication Security layer implements Transport Layer Protection with TLS 1.3 with perfect forward secrecy, Certificate pinning to prevent MITM attacks, HSTS implementation, Protocol downgrade attack prevention, and Mandatory strong cipher suites (minimum AES-256). The API Security features include OAuth 2.0 with JWT for authorization, Request signing with HMAC-SHA256, Nonce implementation for replay attack prevention, Rate limiting with exponential backoff, and IP reputation analysis for API endpoints. Real-time Monitoring functions include Anomaly detection for traffic patterns, Geographical access analysis, Behavioral biometrics for session validation, Custom WAF rules for application-specific threats, and DDoS mitigation technologies.

Data Protection measures include Data-at-Rest Security with AES-256 encryption for locally stored data, Secure key generation using hardware security modules (when available), File-level encryption for sensitive documents, Key rotation policies, and Secure key storage using OS-specific secure enclaves. Additionally, Data-in-Memory Protection includes Sensitive data ephemeral storage, Memory scrubbing after usage, Prevention of memory dumps through OS protections, Secure garbage collection practices, and Guard pages implementation. Database Security features include Field-level encryption for PII, Data tokenization for payment information, Database activity monitoring, Data access audit logging, and Segregation of sensitive data in separate security domains.

Authentication and Authorization mechanisms include Multi-factor Authentication Framework with Primary factors including Password with entropy requirements (minimum 70 bits) and PIN codes (restricted to device-specific operations), and Secondary factors including Time-based one-time passwords (TOTP), SMS verification with rate limiting, and Email verification.

### Integrated Safeguards

The eBono platform has integrated safeguards within the mobile invention to prevent abuse and fraudulent use. General and Indigent Recipients are required to choose from five price categories. These are the categories that are close to the estimated price of the donation(s) request of the Recipient. After the Recipient selects a price category, they will no longer be able to select that price category for a predetermined period of time.

Another safeguard is that a history of the donations received by the Recipient will be recorded. This allows potential Donors to review the amount of support that the Recipient has received. The ability to monitor the support of each Recipient enables the Donor to make a more informed decision in regards to their giving. For example, if a Recipient has been receiving donation support for an extended period of time, the Donor may choose to accept the request from a Recipient who may not have any donation support.

One of the fundamental dilemmas in most charity platforms is the apprehension created when giving monetary donations to what appears to be a worthy cause. Some charity platforms may offer some security by tracking the monies. However, this tracking feature is only effective until the money is deposited into the Recipients account. No one can be sure how the funds are utilized once the money is delivered to the Recipient. Unfortunately, many times the money that Recipients are requesting may not be used for the intended purpose.

This mobile invention eliminates the misappropriation of finances because it is created to only accept donations for the sole purpose of purchasing essential products for the indigent Recipients. At no point does the mobile invention solicit money to be transferred or wired into the account for its users.

Another advantage of the Donor's ability to view the request of the Recipient is that it gives them full autonomy in selecting the cause they choose to support. If a Recipient requests an item that does not seem to be essential (e.g., sunglasses or jewelry), the Donor has the insight to bypass the request of that Recipient.

### Online Payment Services

Payments systems have been implemented within the invention to provide efficient digital payment and tracking methods for agreements between the Donors and the mobile application invention. As used herein, the term “financial transactions” refers to all debit and credit transactions such as those purchased on near-field communication devices, cellular phones, tablets, and web-enabled systems.

The mobile application supports multiple payment options including PayPal, Amazon Pay, eBay Managed Payments, Google Pay, Apple Pay, Direct debit payments, Bank transfers, Prepaid cards, Gift cards, Digital currencies, and Stripe integration.

### Tax-Deductible Donations

Donors who agree to purchase the requested product donations on behalf of the recipient users will be donating the funds through the mobile application invention. These funds will be allocated to the charity organization “eBono” which is identified as a 501c3 nonprofit organization. Once the funds are paid to the charity organization eBono, they will be designated to the Benevolence Funds account within the 501c3 organization. The Benevolence Fund is used to help people who need funds and are facing family hardships due to various reasons like natural calamities, health issues, accidents, or any other natural cause.

When the funds are made available within the mobile application invention, customer service representatives for the mobile application invention will then use those funds to purchase the product donation request on behalf of the donor. Because the funds were donated to the eBono charity organization and purchases are debited/credited through the eBono charity organization through its Benevolence funds, this allows the purchases to be classified as a donation. Charitable gifts made to most nonprofit organizations that are officially recognized by the Internal Revenue Service (IRS) as having 501(c)(3) status are considered to be tax-deductible contributions.

The eBono system provides written acknowledgments to donors in compliance with IRS requirements for tax-deductible contributions. For any single contribution of $250 or more, donors will receive a contemporaneous, written acknowledgment containing: (1) The name of the organization; (2) The amount of cash contribution; (3) A description (but not the value) of non-cash contribution; (4) A statement that no goods or services were provided by the organization in return for the contribution, if that was the case; and (5) A description and good faith estimate of the value of goods or services, if any, that an organization provided in return for the contribution.

### Total Donation Cost Components

Referring to FIG. 13, the total donation cost presented to donors comprises multiple components clearly displayed in the donation interface. The breakdown includes the product cost, applicable taxes, delivery service fees, and administrative fees (labeled as “eBono Service” in the interface). This transparent breakdown ensures donors understand exactly how their contribution is allocated, with the administrative fee supporting the ongoing operations of the platform while maintaining the core commitment that 100% of product-designated funds reach recipients as physical goods. As illustrated in FIG. 13, the system calculates sales tax based on the delivery location, applies appropriate delivery fees based on third-party service rates, and adds a minimal service fee that supports platform operations while ensuring maximum impact of donations.

### Administrative Function

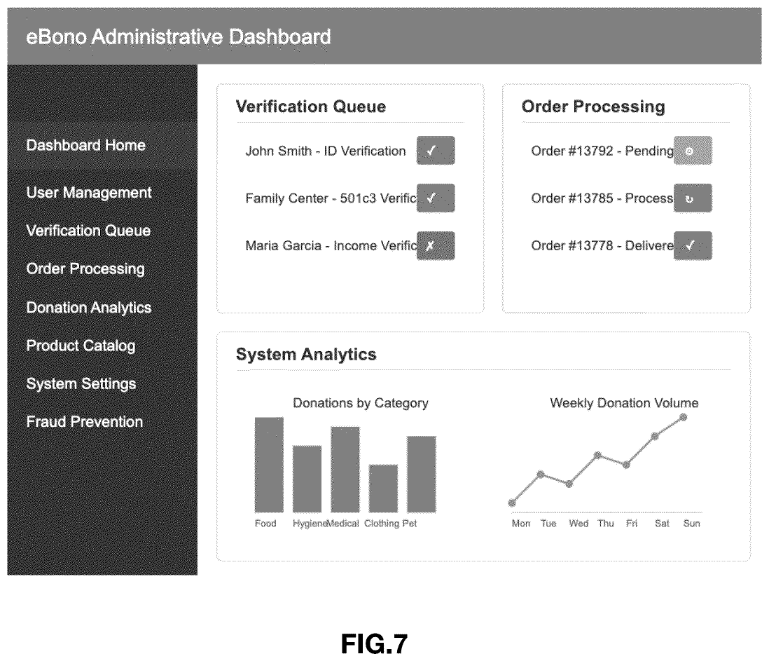

Referring to FIG. 7, the system implements dedicated administrative functions through a specialized administrative interface accessible only to authorized platform personnel. As shown in the administrative dashboard, these functions include manual verification processing for edge cases, fraud detection review, recipient classification override capabilities, campaign moderation, donation facilitation, product catalog management, and third-party service integration management. The administrative module enables monitoring of system health, user behavior analytics, and provides tools for customer service representatives to assist with order processing on behalf of donors when necessary. The verification queue panel shown in FIG. 7 illustrates how administrators can efficiently process identity and organizational verification requests, while the order processing panel demonstrates the workflow for tracking donations from payment to delivery.

### Partial Donation Selection

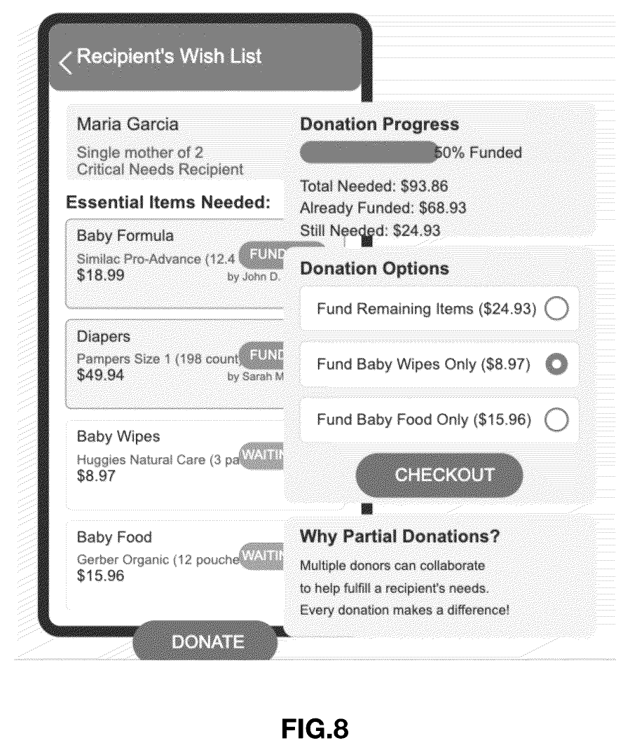

Referring to FIG. 8, the platform uniquely enables partial fulfillment of recipient requests through a sophisticated item-level donation system. As illustrated in the partial donation interface, donors may select specific items from a recipient's request list, with the platform automatically updating the recipient's public profile to reflect items that have been funded and those still awaiting donation. The “Funded” and “Waiting” status indicators shown in FIG. 8 visually communicate which items have been purchased by other donors, and which remain available for new donors to fund. This granular selection process allows multiple donors to collaborate in meeting a recipient's needs without duplication, maximizing the efficiency of the donation ecosystem. The donation progress panel displays the percentage of the recipient's needs that have been met, encouraging additional donors to complete remaining items.

### Charity Selection Capability

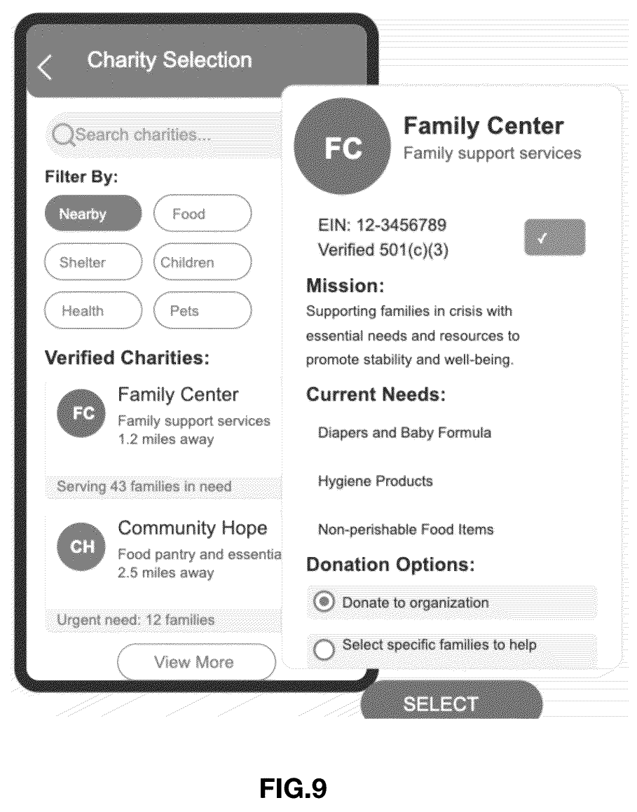

Referring to FIG. 9, donors are provided with a specialized interface for directing their contributions to specific charity organizations registered on the platform. The charity selection interface implements an organization browser with filtering capabilities based on mission focus, geographic area served, and current needs. The detailed charity view shown on the right side of FIG. 9 presents verification information, mission statement, and current needs of the selected charity. Within selected charity organizations, donors may further specify whether their donation should be directed to the general operational needs of the organization or to specific individuals or families being served by that organization, providing unprecedented granularity in charitable giving. This functionality is controlled through the donation options radio buttons shown at the bottom of the detailed charity view.

### Time-Based Recipient Donation Model

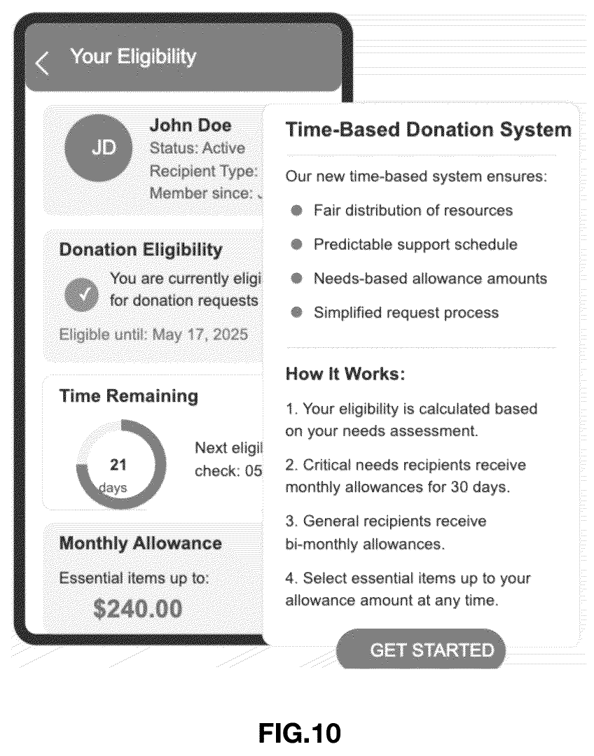

Referring to FIG. 10, the recipient user classification system has been enhanced to implement a time-based donation eligibility model rather than the previous price category selection framework. As illustrated in the time-based donation eligibility interface, recipients now receive a calculated donation allowance based on their needs assessment for a specified time period, typically ranging from 7 to 30 days depending on classification. The circular progress indicator shows recipients how many days remain in their current eligibility period, while the monthly allowance section displays their maximum donation value. At the conclusion of this period, recipients automatically become eligible for additional donation support without requiring re-application, though periodic verification may be triggered based on configurable system parameters. This time-based approach enables more consistent support while maintaining fraud prevention mechanisms.

### Charity Organization Donation Framework

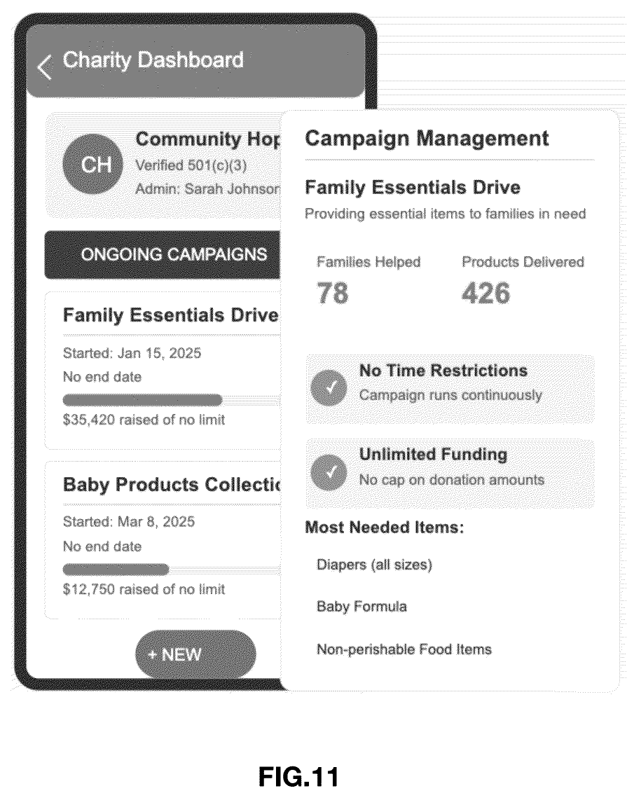

Referring to FIG. 11, unlike individual recipients, verified charity organizations operate under a distinct donation framework that does not impose specific monetary limits or time restrictions. As shown in the charity organization interface with ongoing campaigns, this differentiated approach recognizes the ongoing operational nature of charitable work and the typically higher volume of needs being served. The “No end date” and “No limit” indicators on the campaign cards demonstrate how charity organizations can maintain persistent donation campaigns with dynamic product requests, while the campaign management panel provides analytics on families helped and products delivered. The system implements organizational-level analytics and verification rather than transaction-level restrictions. This framework enables continuous support for organizational missions while maintaining the platform's core principle of direct product delivery.

### Auto-Generated Mobile Functions

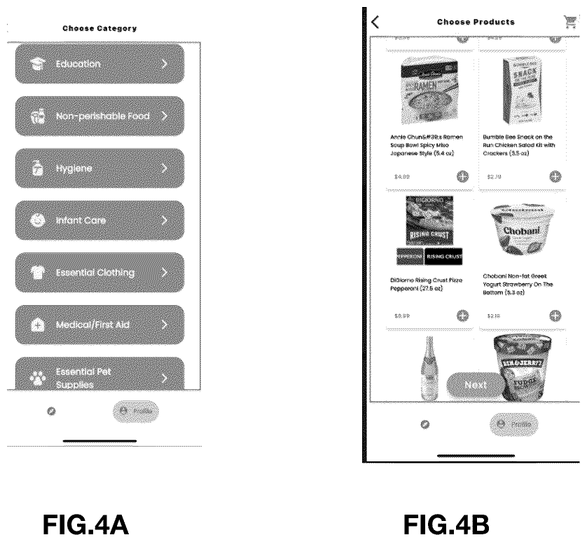

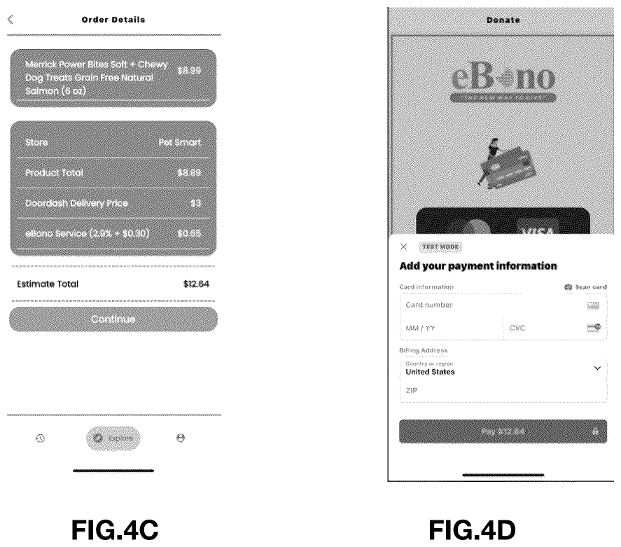

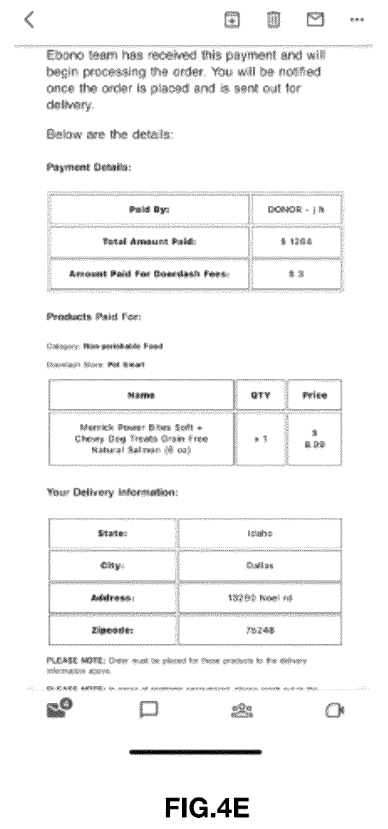

All functions of the mobile application are auto-generated through a sophisticated development pipeline that ensures consistency across operating systems and device types. The system employs dynamic code generation for interface elements, business logic implementation, and third-party service integration, resulting in a unified user experience regardless of device. This auto-generation extends to form creation, validation rules, payment processing interfaces, and notification systems, allowing for rapid deployment of updates and new features without requiring user-initiated application updates. The user interfaces shown in FIGS. 4A-E, 5, and 8-13 are all generated through this automated process, ensuring consistent styling, functionality, and user experience across the platform.

### AI Advancement Integration

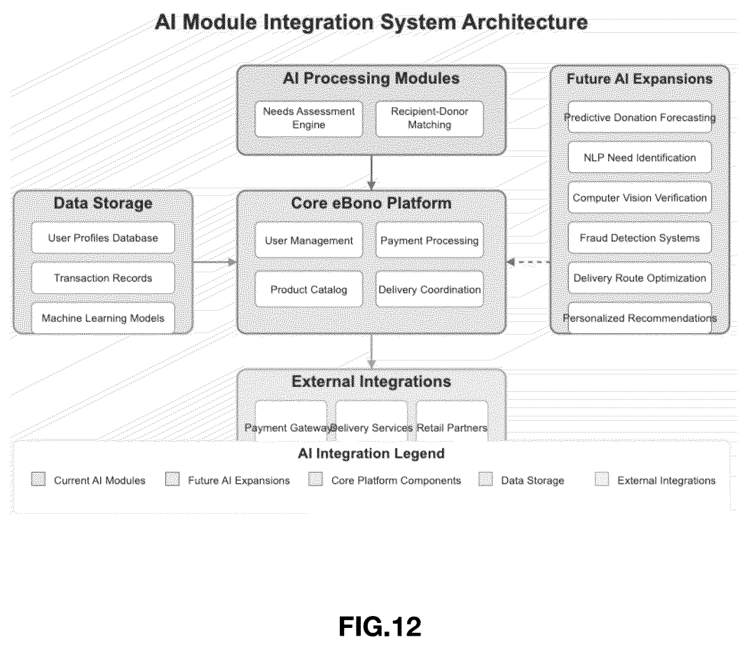

Referring to FIG. 12, the system architecture is designed with extensibility for artificial intelligence advancements, implementing a modular AI integration framework that can incorporate emerging technologies without fundamental platform redesign. As illustrated in the AI module integration system diagram, current AI implementations include the needs assessment engine and matching algorithms, with provisions for future expansion into predictive donation forecasting, natural language processing for need identification, computer vision for verification document processing, anomaly detection for fraud prevention, personalized donor recommendation systems, and autonomous optimization of delivery logistics. The system can adapt to incorporate unforeseen AI advancements through its extensible plugin architecture and regular model retraining capabilities. The connection lines between current AI modules and future expansion opportunities demonstrate the system's capacity for technological growth.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention as claimed.

What is claimed is:

1. A method for product-donation fundraising, the method implemented within a system comprising a processor and a memory, the method comprising the steps of:
generating, by an interface module, an interface for interacting with the system;
creating, by a profile module implemented with the system and upon execution by the processor, a profile of a user, the profile comprising a name and contact details of the user;
associating, by a fintech module implemented with the system and upon execution by the processor, one or more cash accounts to the profile for receiving funds from one or more donors;
providing, by the fintech module, a payment interface for electronically receiving the funds from the one or more donors;
populating, by a networking module, a product donation campaign for presenting essential product needs to the one or more donors for receiving the funds, wherein the campaign has a unique id, wherein the payment interface is coupled to the campaign;
recording transactions relating to transfer of funds from one or more donors in response to the campaign, wherein the transactions are tagged with the unique id of the campaign; and
utilizing the received funds to purchase essential products requested by recipient users and arranging for delivery of those products directly to the recipients via third-party delivery services.

2. The method according to claim 1, wherein the method further comprises the steps of; qualifying users as indigent through an indigency questionnaire based on the United States poverty guidelines for the previous year; coding qualified users as either general or critical needs users based on their responses to the indigency questionnaire.

3. The method according to claim 1, wherein the method further comprises the steps of; providing an interface for transferring funds to a business banking account associated with the mobile application for the purchase of essential products for the recipient user of the mobile application.

4. The method according to claim 1, wherein the method further comprises the steps of; directing recipients and charity organizations to in-app stores that carry essential items recognized in the mobile application; directing recipient users to choose a price category that best reflects the estimated cost of the essential items they are requesting from the specified store; restricting recipient users from selecting the same price category for a specified time period after initial selection; prompting recipient users to select potential donors from their contact list after selecting essential products and price categories; and enabling donors to transfer funds into the business banking account of the mobile application for the purpose of purchasing the requested essential products for the recipient users.

5. The method according to claim 1, wherein the method further comprises the steps of; receiving identification documents of the user for verification purposes.

6. The method according to claim 1, wherein the method further comprises the steps of; providing a main page associated with the user, the main page comprises the name and contact details of the user, information of the essential products requested by the recipient user, and the transactions associated with the product donation requested, wherein the transactions are tracked using the unique id of the product request.

7. The method according to claim 1, wherein the method further comprises the steps of; tracking activities of the Donor in relation to the system; and b. generating rewards/incentive programs for the donors based on their overall contributions.

8. The method according to claim 1, wherein the method further comprises the steps of; automatically generating receipts for the funds received from the one or more donors to avail of any tax benefits; and storing the history of the Donor user's contribution made to the Recipient and Charity organization users.

9. A system for product-donation fundraising, the system comprising a processor and a memory configured to implement a method for; generating, by an interface module, an interface for interacting with the system; creating, by a profile module implemented with the system and upon execution by the processor, a profile of Donor, Recipient, and Charity organization users, the profile comprises contact information such as the user's name and details; associating, by a fintech module implemented with the system and upon execution by the processor, one or more cash accounts to the profile for receiving funds from one or more donors; providing, by the fintech module, a payment interface for electronically receiving the funds from the one or more donors; populating, by a networking module, a campaign for presenting a cause relating to the product donation, to the one or more donors for receiving the funds, wherein the campaign has a unique id, wherein the payment interface is coupled to the campaign; and recording transactions relating to transfer of the funds from the one or more donors in response to the campaign, wherein the transactions are tagged with the unique id of the campaign.

10. The system according to claim 9, wherein the system is further configured to implement the steps of; transferring a portion of cash amount from the one or more cash accounts to a product-donation automatically based on predetermined instructions.

11. The system according to claim 9, wherein the system is further configured to implement the steps of; providing an interface for transferring the funds to one or more recipients of charity.

12. The system according to claim 11, wherein the system is further configured to implement the steps of; selecting a donor from the one or more donors from whom the funds are transferred to the one or more recipients.

13. The system according to claim 9, wherein the system is further configured to implement the steps of; receiving identification documents of the user for verification.

14. The system according to claim 9, wherein the system is further configured to implement the steps of; providing a main page associated with the user, the main page comprises the name and the contact detail of the user, information of the campaign, and the transactions associated with the campaign, wherein the transactions are tracked using the unique id and user name associated with the campaign.

15. The system according to claim 9, wherein the system is further configured to implement the steps of; automatically generating receipts to reflect what was purchased, the cost, the date, the location of delivery, and a history of all transactions and donation funds received from the one or more donors to avail of any benefits.

16. The system according to claim 9, wherein the system is further configured to implement the steps of; disabling the Recipient user's account for a specified period of time after the Recipient user selects a price category.

17. The system according to claim 9, further comprising a database-driven system for connecting indigent recipients with donors for product donations, the system comprising; a needs assessment engine that analyzes user-provided information against poverty guidelines to classify users as general or critical needs recipients; a product selection interface allowing recipients to browse and select essential products from partnered retailers; a donor matching system that connects recipients with potential donors based on need priority, geographic proximity, and donation history; a payment processing system that securely processes donor contributions without directly transferring funds to recipients; a third-party delivery integration module that coordinates product purchase and delivery directly to recipients; and a digital receipt generator that provides tax documentation for charitable contributions.

18. A method for preventing misappropriation of charitable funds, the method comprising; authenticating users through a multi-factor verification process; categorizing users based on financial need using an automated assessment engine; enabling recipients to select essential products from approved retailers; processing donor payments through a secure financial infrastructure; transmitting purchase orders directly to third-party delivery services; tracking delivery status in real-time; and generating donation receipts and tax documentation.

19. The system of claim 9, further comprising a mobile application system for donation-based essential product delivery comprising; a user classification module that differentiates between general recipients, critical needs recipients, donors, and charity organizations; a geolocation service that optimizes delivery routing and recipient-donor matching; a contact list integration feature enabling targeted donation requests; a price category restriction system that prevents abuse through time-limited request frequencies; a donation history tracking system providing transparency for donor decision-making; and a security architecture implementing multi-layer protection for user data and financial transactions.

20. The method of claim 18, further comprising creating recipient profiles including need classification based on financial assessment; enabling recipients to browse and select essential products from partnered retailers; calculating total costs including products, delivery, taxes, and administrative fees; displaying product donation campaigns to potential donors; processing donor payments through a non-profit financial infrastructure; coordinating product purchase and delivery through third-party services; and tracking all transactions with unique identifiers for compliance and verification.
